(19) United States
(12) Patent Application Publication
(10) Pub. No.: US 2015/0370670 A1
(43) Pub. Date: Dec. 24, 2015

(54) METHOD OF CHANNEL CONTENT REBUILD VIA RAID IN ULTRA HIGH CAPACITY SSD

(71) Applicant: NXGN DATA, INC., Irvine, CA (US)

(72) Inventor: Guangming Lu, Irvine, CA (US)

(21) Appl. No.: 14/741,929

(22) Filed: Jun. 17, 2015

Related U.S. Application Data
(60) Provisional application No. 62/013,937, filed on Jun. 18, 2014.

(51) Int. Cl. G06F 11/20; G06F 11/30

(52) U.S. Cl. CPC G06F 11/2094; G06F 11/3055; G06F 11/3037; G06F 2201/86

(57) ABSTRACT

The solution described here is a method to rebuild channel content via RAID approach in the field after one channel is replaced by a new flash channel module depicted in “Invention Disclosure Form-UHC”.

### CROSS-REFERENCE TO RELATED APPLICATION(S)

The present application claims priority to and the benefit of U.S. Provisional Application No. 62/013937 , filed Jun. 18, 2014, entitled “METHOD OF CHANNEL CONTENT REBUILD VIA RAID IN ULTRA HIGH CAPACITY SSD”, the entire content of which is incorporated herein by reference.

### FIELD

One or more aspects of embodiments according to the present invention relate to a method of channel content rebuild via raid in ultra high capacity SSD.

### BACKGROUND

Enterprises and cloud service providers continue to experience dramatic growth in the amount of data stored in private and public clouds. As a result, data storage costs are rising rapidly because a single high-performance storage tier is often used for all cloud data. However, much of the ever-increasing volume of information is “cold data”—data that is infrequently accessed. There's considerable potential to reduce cloud costs by moving this data to a lower-cost cold storage tier. Cold storage is emerging as a significant trend.

### SUMMARY

Aspects of embodiments of the present disclosure are directed toward a method of channel content rebuild via raid in ultra high capacity SSD.

### BRIEF DESCRIPTION OF THE DRAWINGS

These and other features and advantages of the present invention will be appreciated and understood with reference to the specification, claims and appended drawings wherein:

FIG. 1 is a drawing of an SSD with modular flash channel design according to an embodiment of the present invention;

FIG. 2 is a drawing of an SSD internal data partition according to an embodiment of the present invention;

FIG. 3 is a drawing of an XOR RAID cross channels with RAID 4 according to an embodiment of the present invention;

FIG. 4 is a drawing of multiple copies of firmware crossing flash channel according to an embodiment of the present invention; and

FIG. 5 is a drawing of an idealized UHC SSD rebuild time through XOR approach and its comparison according to an embodiment of the present invention.

### DETAILED DESCRIPTION

The detailed description set forth below in connection with the appended drawings is intended as a description of exemplary embodiments of a Method of Channel Content Rebuild Via Raid in Ultra High Capacity SSD provided in accordance with the present invention and is not intended to represent the only forms in which the present invention may be constructed or utilized.

The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

Keywords

FPGA—Field Programmable Gate Array

RAID—Redundant Array of Inexpensive Drives/Devices

SoC—System on a Chip

SSD—Solid State Drive

UHC—Ultra High Capacity

ECC—Error Correction Codes

### BACKGROUND INFORMATION

Cold storage usage models include backup, disaster recovery, archiving, and social media applications. The following four interrelated requirements are relevant to most cold storage usage models.

Expected storage life. Cold storage is designed for persistent rather than transient data. It is triggered by the fact that the data is considered important enough to retain and therefore requires long-term storage.

Access frequency. As data ages, it tends to be less frequently accessed and therefore becomes more suited to cold storage. Data is moved to cold storage based on the date and time it was last accessed.

Access speed. Cold storage explicitly assumes that lower performance is acceptable for older data.

Cost. The benefit of cold storage is the reduced cost of storing older and less frequently accessed data. For some usage models, this overrides any other considerations.

The disclosure in the attached “Ultra High Capacity SSD” shows great cost advantage. With the extremely high number of memory components being used in conjunction with a single controller, a modular approach to the design can be used to offset the risks in yield during manufacturing and high cost of field failures.

Moreover, this disclosure addresses the advantage to rebuild the data in the field once the failure modular channel flash is replaced by a new one.

### DETAILS OF VARIOUS EMBODIMENTS

The high capacity SSD is created to lower the cost per GB. Usually, it has capacity of multiple terabytes or even tens of terabyte at current technology. The whole SSD is still quite expensive though cost per GB is low. Under the control of the SSD controller, typically there are many NAND flash channels. Each channel has many NAND flash dice/packages. For example, for a 32 T SSD with 16 NAND flash channels configuration, there is 2 T capacity for each channel.

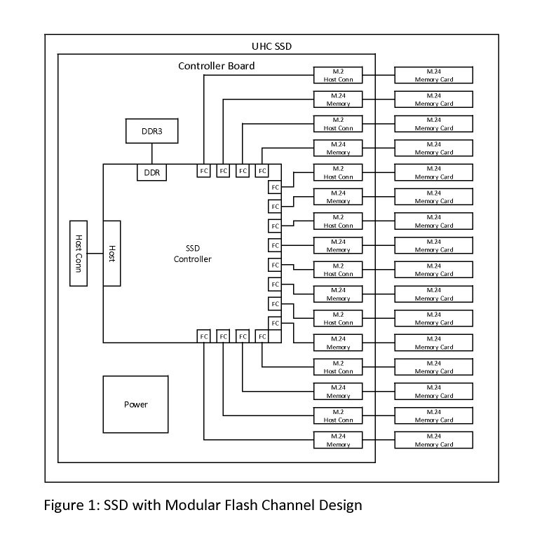

One possible instantiations of the modular flash channel is depicted in FIG. 1.

It is highly beneficial and cost effective for this modular design. In normal SSD with RAID function, if some blocks/dice become bad, technically the SSD is still functional via RAID re-build if the access to bad blocks/dice/packages happens. Normally RAID recovery is much slower in throughput and consumes much more power. In the non-modular SSD flash channel design, typically after RAID recovery, bad block/die will be retired through the garbage collection function with the shrunk SSD capacity.

However, for the modular SSD flash channel design, it is possible to directly replace one of the bad flash channels while maintaining the SSD capacity. With proper firmware design, the SSD integrity can still be maintained.

SSD Integrity and RAID Rebuild

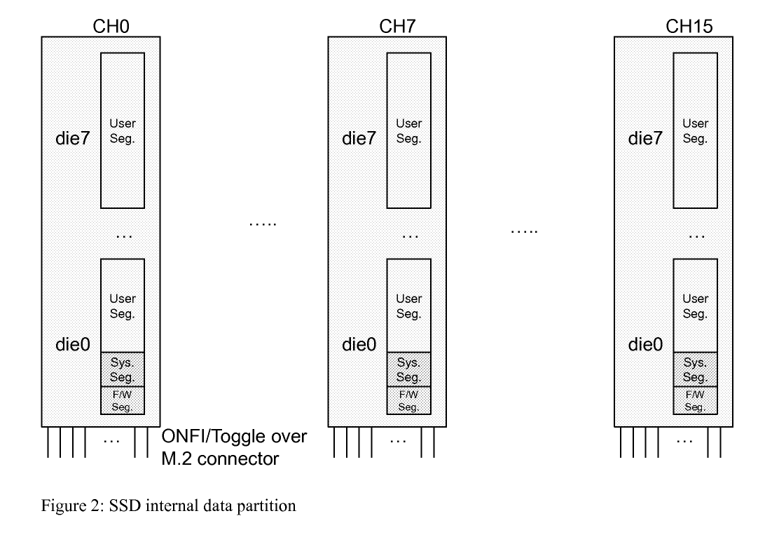

As shown in FIG. 2, it is the configuration example of 16 flash channels, 8 dice/channel.

Normally, the whole SSD space is divided multiple segments. There are at least 3 necessary segments: firmware segment, system map and information segment and user data segment. Firmware segment is used to store the SSD firmware. System map and information segment is used to store the NAND flash management information, for instance the logical to physical mapping table, physical to logic mapping table, NAND block information etc. Typically the firmware and system segments take only a small percentage of capacity compared to the user data segment.

Once a NAND flash channel is replaced by a new one, all of the information in the old flash channel module is lost. Moreover, it is almost not possible to image data in the swap-out channel to the new swap-in channel using external equipment due to lack of critical flash management information.

The following method is used to maintain the data and system integrity after channel swap without other equipment. Let's use the configuration of 16 flash channel, and 32 T cold storage SSD as an example.

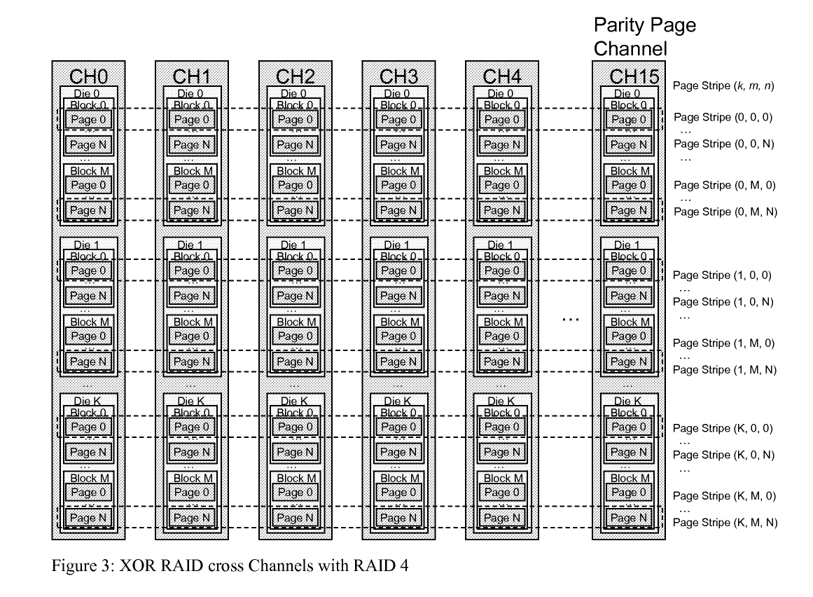

As shown in FIG. 3, only one die in each channel except the parity channel can participate the XOR RAID parity generation for each stripe when building the XOR RAID parity channel. The parity can be in RAID 4 or RAID 5 mode. This will prevent two or more pages from missing in each page stripe once one channel module is removed. Regardless the RAID approach (for example, RAID 6 using Reed-Solomon or 2-Dimensional XOR approach instead of regular XOR), the parity overhead will remain the same if the RAID is designed to enable the feature of flash channel swap in the service field. It is 1/CH_NUM, where CH_NUM is the total number of channels. Certainly, if the RAID is designed for extra page or block failure protection, then it can be freely extended much longer stripe length. In such case, more blocks or dice from the same channel module will be in the same RAID parity stripe.

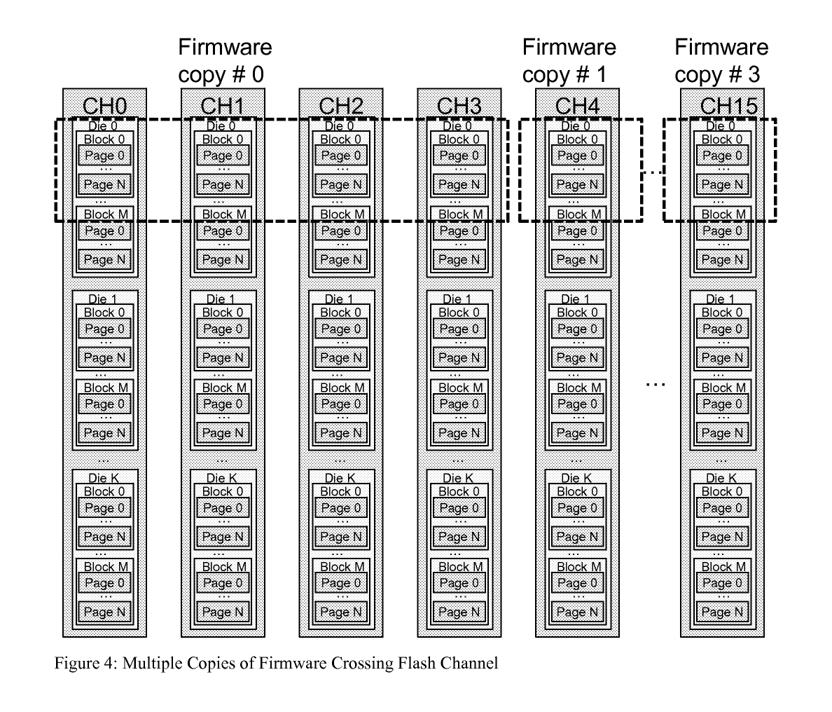

Since firmware segment is very small, multiple copies are stored in different flash channel. For the case of 4 copies of firmware, as shown in FIG. 4 channel 0-3 can store a whole copy of firmware, while channel 4-7, channel 8-11, channel 12-15 stores another copy of complete firmware respective for the redundancy. Typical firmware size is less than 1 GB. Firmware segment is almost static. In other words, very few write to firmware segment after the fabrication. A complete set of firmware needs to avoid crossing all of the flash channel module in order to support the field serviceable capability.

In the other hands, system map and information segment is also relative small (though it is much larger than firmware segment), 2 copies are stored in different flash channel. Similarly as shown in FIG. 4 for the case of 2 copies of system segment, channel 0-7 will store a whole copy of system mapping data, while channel 8-15 stores another identical copy of complete system mapping data for the redundancy. Channel 8-15 is the image of channel 0-7. Whenever there is a write to channel 0-7, the same data will be written to channel 8-15. If some block stripes are garbage-collected and erased in channel 0-7, the same block stripes in channel 8-15 will be erased as well. Typical system segment size is around 1 GB for each 1 TB user data. So in the 32 T configuration, the system segment is about 32 GB. Unlike the firmware segment, system segment update/erase data consistently if new data is written into the SSD. However in the cold storage system, the data update doesn't happen often.

With the above preparation, the complete firmware and system data are still available in the SSD though one flash channel is replaced.

Once the power-on after the channel replacement, the boot-up code will boot the UHC SSD from the one of the remaining complete copy of firmware. Firmware can build-up the complete mapping table from the second copy of system segment. After that, the missing firmware and system data can be copied back from other copies in order to maintain the multiple complete firmware and system segment data in the UHC SSD system.

Due to the fact that it takes long time for the NAND flash programming (more than 1 ms for the TLC programming), the page recovery should be interleaved among multiple dice so as to maximize the throughput for the replaced channel. The data recovery pseudo-code is presented as following:

```
For(m =0; m<M; m++)
  For(n =0; n<N; n++)
    For(k=0; k<K; k++)
      {
      For(i=0; i<CH_NUM; i++)
        {
        If( i != Replaced_Channel) read back page(i, k, m, n)
        XOR decoded pages.
        }
      Write recovered data to page(Replaced_Channel, k, m, n)
      }
```

page (i, k, m, n) means a page in channel i, die k, block m and page n.

Where M is the number of flash blocks in each die; N is the number of pages in each block; K is the number of dice in each flash channel; CH NUM is the number of flash channel.

The total time of SSD drive re-build is highly dependent on the SSD controller configuration especially limited by ECC decoding resource since all of the data need to go to ECC decoder first before they can be XORed. The rebuild time is also affected by the number of flash planes.

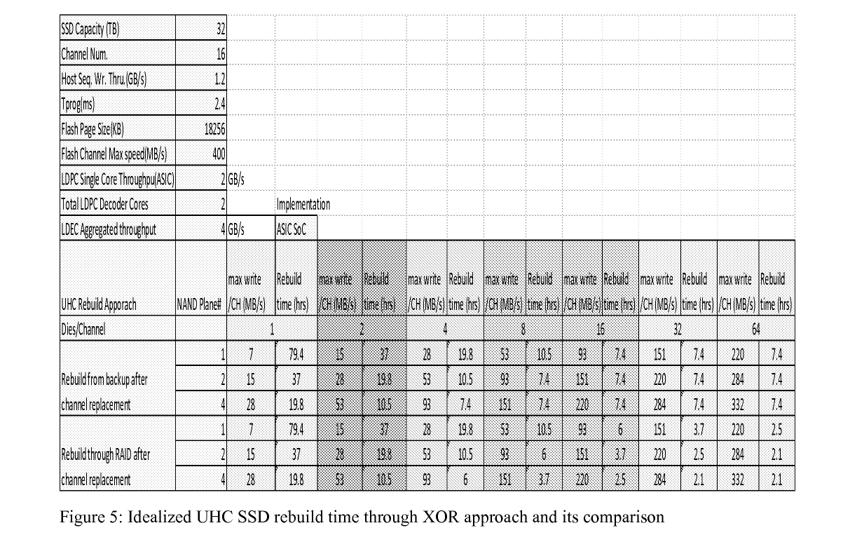

FIG. 5 shows the SSD rebuild time using XOR approach. It also compares with the rebuild time through host interface.

After the XOR re-build, the SSD is back to normal operational mode. However in the rebuild time, the SSD is still functional with degraded performance.

### Advantages/Benefits of Embodiments of the Invention

Modular design and architectural features of the product that facilitate the field reliability and robustness by:

1. Continued operation of the system (with degraded performance) if a storage element fails

2. Simplified replacement and automatic recovery of the lost information using the integrated redundancy and modularity of the solution

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a Method of Channel Content Rebuild Via Raid in Ultra High Capacity SSD have been specifically described and illustrated herein, many modifications and variations will be apparent to those skilled in the art. Accordingly, it is to be understood that a Method of Channel Content Rebuild Via Raid in Ultra High Capacity SSD constructed according to principles of this invention may be embodied other than as specifically described herein. The invention is also defined in the following claims, and equivalents thereof

What is claimed is:

1. An SSD storage device that uses modular storage elements to maintain a level of flexibility and reparability.

2. The SSD system that one defunct flash channel module can be replaced by a new one.

3. The SSD system that has 2 or more copies of firmware and system map information and each complete copy only resides a sub set of all of the flash channel.

4. The SSD system that has complete firmware and system map information even a flash channel is replaced.

5. The SSD system that can re-build the whole drive after flash channel replacement without other equipment.

6. The SSD system that reads page stripes in an interleaving way so as to allow the programming of data to replacement channel in the same interleaving way to maximize the programming speed.
